(19) United States
(12) Patent Application Publication
(10) Pub. No.: US 2007/0110972 A1
(43) Pub. Date: May 17, 2007

(54) Packaging material for sterile products

(76) Inventor: Manfred Hoffmann, Konstanz (DE)

Correspondence Address: BACHMAN & LAPOINTE, P.C., 900 CHAPEL STREET, SUITE 1201, NEW HAVEN, CT, 06510, US

(21) Appl. No.: 11/651,187

(22) Filed: Jan. 8, 2007

Related U.S. Application Data
(62) Division of application No. 10/399,623, filed on Oct. 6, 2003.

(30) Foreign Application Priority Data
Oct. 20, 2000 (EP) 00810976.1

(51) Int. Cl. B32B 7/02

(52) U.S. Cl. 428/216

(57) ABSTRACT

A flexible packaging material for sterile items, made from a film, or a film composite (B) with barrier properties, comprises a support film made from polyamide, polyester, or polypropylene and a thin ceramic layer arranged thereon. A functional layer containing, or made from an inorganic/organic hybrid polymer is applied to the thin ceramic layer on the support film.

### CROSS REFERENCE TO RELATED APPLICATIONS

This application is the U.S. divisional application of U.S. application Ser. No. 10/399,623 filed Apr. 21, 2003 which is a U.S. national phase application of PCT/EP2001/11802 filed Oct. 12, 2001 which claims priority of European Application No. 00810976.1 filed Oct. 20, 2000.

### BACKGROUND OF THE INVENTION

The present invention relates to a flexible packaging material for sterile products, and a method for its production and the use of the film or the film composite.

Flexible packaging materials for sterile products, i.e. flexible sterilisable packaging materials, are used in the food packaging field for the sterile packaging of food for humans and animals. The packaging materials mentioned are used, in particular as bag packagings in the most varied designs.

Flexible packaging materials for sterile products are distinguished by their sterilisability. In other words, in comparison to normal, flexible packaging materials, they have to withstand the high stresses emanating from the sterilisation processes. In the process, the packaging materials should, as far as possible, keep their advantageous properties, such as gas tightness, and should not be damaged.

During sterilisation, the packaging materials are heated over a certain period, i.e. for example a few minutes, to temperatures of above 100° C. and are thus subjected to high thermal stresses. So that all germs and pathogens are completely killed, the packaging product, in particular meat-containing packaging product, is generally sterilised at very high temperatures from, for example, 130° C. to 140° C. However, under such extreme sterilisation conditions the demands on the packaging materials increase enormously.

For these reasons, only a few flexible packaging materials can be used as packaging materials for sterile products.

The majority of flexible packaging materials for sterile products generally contain, for reasons of aesthetics, economy and ecology, films and/or layers made of plastics material, the use of metal foils being dispensed with as far as possible.

Flexible packaging materials for sterile products frequently also need to have barrier properties with respect to gases; for example oxygen or carbon dioxide, or water vapour or aromatic materials. As the plastic films or layers of the packaging materials generally have an inadequate barrier effect, the packaging materials comprise further films or layers with particular barrier properties.

Examples of barrier materials currently used in the packaging industry are metals such as aluminium, polymers (EVOH or PVDC), polymers which are vapour-phase coated with thin metallic or ceramic layers, or corresponding material combinations.

DE 196 50 286 describes films or film composites with a backing layer made of a plastics material and a thin oxide layer arranged thereon as the barrier layer and, on the thin oxide layer, a further layer made of an inorganic-organic hybrid polymer, a so-called ORMOCER®, with a layer thickness of 1 to 15 μm. The arrangement of an ORMOCER® layer of this type on the thin oxide layer is to increase the barrier effect of the film composite.

Furthermore, U.S. Pat. No. 5,645,923 also describes films or film composites with a backing film made of a plastics material, and arranged thereon, a thin oxide layer as the barrier layer. Arranged on the thin oxide layer is a further layer made of a sol-gel lacquer produced according to the sol-gel method. The arrangement of this sol-gel lacquer on the thin oxide layer is to increase the barrier effect of the film composite.

However, not all the mentioned barrier materials are suitable for use in packaging materials for sterile products and certain barrier materials, for example the ORMOCER®e mentioned or general sol-gel lacquers are, moreover, very expensive in the quantities suggested for use.

Sterilisable film composites are known, for example, which consist of a composite made of plastic films or plastic laminates and a water vapour-tight and gas-tight barrier layer in the form of a metal film. Metal films or metal coatings are excellently suitable as packaging materials for sterile products and moreover have excellent barrier properties. For ecological reasons and in view of the increasing need for sorted packagings, metal contents in plastic packagings are not desired. Furthermore, quality control of the packaging product, such as, for example, the detection of possible metal parts in the packaging product is much simpler with metal-free packaging materials. Nowadays, transparent packaging films are increasingly demanded which cannot be achieved by the use of metal barrier layers. It should also be possible to prepare food in the sterile product packagings in microwave appliances, which assumes metal-free packaging materials for sterile products.

Sterilisable film composites are also known which comprise oxide-coated plastic films, the comparatively thin oxide layer on the plastic film taking on the function of the barrier layer.

However, the thermal stressing of the packaging material for sterile products during sterilisation generally leads to an impairment of its barrier properties. A massive, irreversible impairment of the barrier properties can occur under extreme sterilisation conditions. Thus, for example, the oxygen permeability of a conventional sterilisable packaging film may increase by a factor of 3 to 20 in extreme sterilisation conditions.

The object of the present invention is therefore to provide a flexible packaging material for sterile products made of a film or a film composite with barrier properties with respect to gases, water vapour and aromatic materials, these properties remaining durable in particular even in extreme sterilisation conditions. The flexible packaging material for sterile products designed as a mass-produced item should also be economical to produce. The flexible packaging material for sterile products should, as far as possible, also be sortable and, if necessary, should be producible in transparent design.

### SUMMARY OF THE INVENTION

The foregoing is achieved according to the invention by a flexible packaging material for sterile products made of a film or a film composite (B) with barrier properties, comprising a backing film (11) made of polyamide, polyester or polypropylene and a thin ceramic layer (12) arranged thereon, characterised in that a functional layer comprising or consisting of an inorganic-organic hybrid polymer (13) is arranged on the thin ceramic layer (12) of the backing film (11).

### BRIEF DESCRIPTION OF THE DRAWINGS

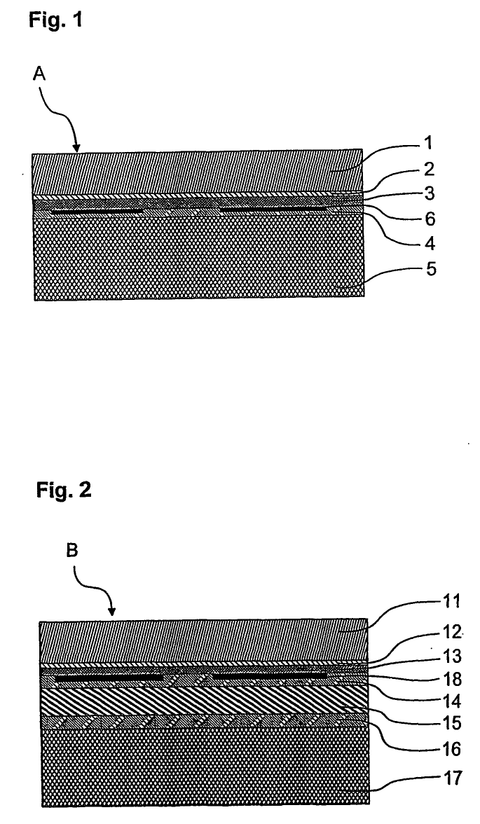

The schematic construction of a plurality of embodiment variations of the packaging materials for sterile products according to the invention will be described in more detail hereinafter with reference to FIGS. 1, 2, 3, 4 and 5 which illustrate composite films according to the invention.

### DETAILED DESCRIPTION

The inorganic-organic hybrid polymers are expediently available as lacquer systems. Inorganic-organic hybrid polymers are also called ORMOCER®e.

Surprisingly, it has been shown that owing to the use according to the invention of a comparatively very thin functional layer of an inorganic-organic hybrid polymer in the claimed sterile product packaging film, the irreversible decrease, caused by sterilisation, in the barrier effect with respect to gases such as carbon dioxide and in particular oxygen and water vapour can be substantially reduced. Practically no, or only a slight, decrease in the barrier effect occurs in the case of an increase in the sterilisation temperature from, for example, 120° C. to 135° C. owing to the functional layer.

As the layer sequence with a thin ceramic layer and a functional layer of an inorganic-organic hybrid polymer itself has better barrier properties than the thin ceramic layer alone, an additional increase in the barrier effect is simultaneously achieved, independently of the sterilisation conditions, so the packaging material for sterile products according to the invention has an excellent durable barrier effect even under extreme sterilisation conditions.

The functional layer is preferably an inorganic-organic hybrid polymer synthesised by the sol-gel method. To produce it, an inorganic network is originally constructed by controlled hydrolysis and condensation of organically modified Si-alkoxides, i.e. organo-functional silanes. The network can also be modified in a targeted manner by the so-called sol-gel process by co-condensation with other metal alkoxides, in particular with aluminium alkoxides. The polymerisable groups fixed to an inorganic network are then crosslinked with one another, in a redox initiated manner or by means of energy-rich radiation (for example UV radiation), in other words the organo-functional groups are polymerised, and this brings about the construction of an additional organic network. For example, reactive methacrylate, epoxy or vinyl groups are polymerised by thermal or photochemical induction. In addition, non-crosslinkable organically modified Si-alkoxides can be used, which do not undergo any organic polymerisation reactions and therefore contribute to an organic functionalisation of the inorganic network. An inorganic-organic hybrid polymer is constructed by the described two-stage method. The inorganic-organic hybrid polymer is, for example, methyl alcohol-containing and preferably methyl alcohol-free.

Used in the production of the inorganic-organic hybrid polymer is preferably at least one crosslinkable organo-functional silane and in particular a crosslinkable organo-functional silane of the following formula (I):
R′ₘSiX₍₄₋ₘ₎ (I),
wherein the X groups, which may be the same or different, represent hydrogen, halogen, alkoxy, acyloxy, alkyl carbonyl, alkoxy carbonyl or —NR″2 (R″═H and/or alkyl) and the R′ radicals, which may be the same or different, represent alkyl alkenyl, alkinyl, aryl, arylakyl, alkylaryl, arylakenyl, alkenylaryl, arylalkinyl or alkinylaryl, wherein these radicals may be interrupted by O- or S-atoms or the group —NR″ and may carry one or more substituents from the halogen group and the optionally substituted amino, amide, aldehyde, keto, alkylcarbonyl, carboxy, mercapto, cyano, hydroxy, alkoxy, alkoxycarbonyl, sulphonic acid, phosphoric acid, acryloxy, methacryloxy, epoxy or vinyl groups and m has the value 1, 2 or 3, and/or an oligomer derived therefrom, wherein the R∝ radical and/or the substituent must be a crosslinkable radical and/or substituent.

Examples of crosslinkable, organo-functional silanes are vinyltrimethoxysilane, aminopropyltriethoxysilane, isocyanatopropyltriethoxysilane, mercaptopropyltrimethoxysilane, vinyltriethoxysilanes, vinylethyldichlorosilanes, vinylmethyldiacetoxysilanes, vinylmethyldichlorosilanes, vinylmethyldiethoxysilanes, vinyltriacetoxysilanes, vinyltrichlorosilanes, phenylvinyldiethoxysilanes, phenylallyldichlorosilanes, 3-isocyanotoporyltriethoxysilanes, methacryloxypropenyltrimethoxysilanes, 3-methacryloxypropyltrimethoxysilanes.

The inorganic-organic hybrid polymers which can be used according to the invention comprise all the inorganic-organic hybrid polymers previously known in the prior art. Suitable inorganic-organic hybrid polymers are, for example, ORMOCER®e as described by name in the Offenlegungsschriften DE 38 28 098 and DE 43 03 570 and to which reference is explicitly made. Explicit reference is also made, for a more detailed description of this ORMOCER®e and its composition to DE 196 50 286.

Hereinafter, the exemplary composition of two suitable lacquer systems known as ORMOCER®e, of an inorganic-organic hybrid polymer is described:

Lacquer system 1:

| | |
|---|---|
| TMOS | 30 to 50, preferably 40 mol % |
| Al(Obu^{a})₃ | 10 to 15, preferably 12.5 mol % |
| GLYMO | 30 to 35, preferably 32.5 mol % |
| Zr(Opr)₄ | 5 to 15, preferably 10 mol % |
| AMEO | 3 to 8, preferably 5 mol % |

This lacquer system is thermally cured at a temperature of 130° C. or less.

Lacquer system 2:

| | |
|---|---|
| MEMO | 60 to 80, preferably 70 mol % |
| Methacrylic acid | 10 to 20, preferably 15 mol % |
| Zr(Opr)₄ | 10 to 20, preferably 15 mol % |

This lacquer system is cured by photochemical or thermal induction.

The abbreviations mean:

| | |
|---|---|
| MEMO | 3-methacryloxypropyltrimethoxysilane |
| TMOS | Tetramethoxysilane |
| Al(Obu^{a})₃ | Aluminiumtrisecondarybutylate |
| GLYMO | 3-glycidyloxypropyltrimethoxysilane |
| Zr(Opr)₄ | Zirconiumtetrapropylate |
| AMEO | 3-aminopropyltriethoxysilane |

The backing layer of the packaging material for sterile products according to the invention coated with a thin ceramic layer is expediently made of a polyester, in particular a polyethylene terephthalate (PET), a polyamide, in particular an oriented polyamide (oPA), or a polypropylene, in particular a cast polypropylene (cPP). The backing film may, for example, be the outer or inner, exposed film in the film composite. Further films or layers may be arranged, in particular laminated on, either side of the coated backing film according to the invention, so the coated backing film does not form a free surface. The packaging material for sterile products may also be a film made of a backing film coated according to the invention and optionally printed.

The outer, exposed film means the film in the film composite forming a free surface optionally coated according to the invention and remote from the packaging content of the packaging to be produced therefrom, whereas the inner, exposed film is the film in the film composite forming a free surface, optionally coated according to the invention and facing the packaging content of the packaging to be produced therefrom.

The backing film expediently has a thickness of 5 to 100 μm, preferably 5 to 50 μm and in particular 5 to 20 μm.

The thin ceramic layer is preferably a thin oxide layer, in particular a silica of the formula SiO_{X}, wherein x is a number from 1 to 2 or an aluminium oxide of the formula Al_{y}O_{z}, wherein y/z represents a number from 0.2 to 1.5, or a mixture thereof. In the preferred embodiment according to the invention the thin ceramic layer is made of SiO₂ or of Al₂O₃ or a mixture thereof. Apart from said silica and aluminium oxides, the thin ceramic layer may also comprise oxides and/or nitrides of metals and/or semi-metals, for example those of iron, nickel, chromium, tantalum, molybdenum, hafnium, titanium, yttrium, zirconium, magnesium and mixtures of these substances, or may consist thereof.

The thin ceramic layer expediently comprises a layer thickness of 5 to 200 nm, preferably 20 to 150 nm and in particular from 50 to 100 nm. The thin ceramic layer may be applied, for example by a vacuum thin layer method, such as physical coating methods (PVD methods) or chemical coating methods (CVD methods) with or without plasma support, or may be applied by sputtering. Physical coating methods are preferred, in particular based on electron-beam evaporation, resistance heating or inductive heating from crucibles.

The functional layer containing or consisting of an inorganic-organic hybrid polymer is, for example, applied in a mass per unit area of 0.1 to 5 g/m². In a preferred embodiment, the mentioned functional layer is applied to the thin ceramic layer in a mass per unit area between 0.1 and 1 g/M² and in particular between 0.5 and 1 g/m². The functional layer is present, for example, in a layer thickness of 0.1 to 5 μm. In the preferred embodiment the functional layer is present in a layer thickness of less than 1 μm, preferably less than 0.8 μm and more than 0.1 μm, preferably more than 0.5 μm.

The functional layer containing or consisting of an inorganic-organic hybrid polymer is preferably applied by means of a printing method, in particular gravure method, to the thin ceramic layer. However, the functional layer may also be applied to the thin ceramic layer by means of painting, spraying, rolling, centrifugal or knife methods.

Printing or counter-printing is applied to the mentioned functional layer in a particular embodiment of the invention. The print is preferably applied by means of a printing method, in particular a gravure printing method.

The thin ceramic layer and the functional layer comprising or consisting of an inorganic-organic hybrid 30 polymer may be arranged on the surface of the backing film facing the packaging content or remote therefrom. Said functional layer and the printing thereof may form the outer, exposed surface of the film composite. However, in a preferred embodiment one or more further films or composite films made of, for example, polyester, polyamide or polypropylene are arranged by way of a laminating adhesive on the functional layer or on the printing thereof.

The film or film composite of the packaging material for sterile products preferably comprises a sealable, inner, exposed film or layer made of, for example, polypropylene, in particular made of cast polypropylene (cPP). The backing film itself may form the sealable, inner, exposed film in the film composite.

The packaging material for sterile products may comprise films or layers made of polyester, in particular a backing film made of polyester, for example, made of a terephthalate (PET) such as A-PET, PETP, PETG or G-PET.

The films or layers, and in particular the backing film, can be made of polyamide, for example made of a polyamide 6, polyamide 11, polyamide 12, polyamide 6.6, polyamide 6.10, polyamide 6.12 or polyamide 6-3-T, and of a mixture thereof. The films made of polyamide may be unstretched or uni-axially or bi-axially oriented. The films made of polyamide, in particular when used as a backing film, are preferably made of an oriented, in particular bi-axially oriented, polyamide.

The packaging material for sterile products may also comprise films or layers, in particular a sealable, inner, exposed film or layer made of polypropylene, for example of an isotactic, syndiotactic or atactic polypropylene or a mixture thereof.

The polypropylene may be amorphous, partially crystalline, crystalline or highly crystalline. The polypropylene is preferably a cast polypropylene.

The individual films of the film composite are preferably laminated against each other. The laminating adhesive may be a solvent-containing, solvent-free or water-containing laminating adhesive and preferably a polyurethane adhesive system or a polyester/polyurethane adhesive system. Adhesives which cure under the effect of energy-rich radiation (for example UV or electron-beams) could also be used. In view of the preferred use of the film or the film composite in the food sector, physiologically harmless adhesive systems are to be preferred. Particularly suitable adhesive systems are aliphatic systems. The laminating adhesive may be applied, for example, by casting, painting, spraying, knife application, surface rolling etc.

The films of the composite films may also be connected by way of a bonding agent and/or primer. Products based on maleic acid and modified polypropylene may be used, for example, as bonding agents.

The laminating adhesive, like the bonding agent or primer, may, for example, be used in quantities of 0.5 to 10 g/m², preferably in quantities of 1 to 8 g/m² and in particular quantities of 2 to 6 g/m². The laminating adhesive and also the bonding agent or primer may be used in quantities such that, for example, layers of 0.1 to 15 μm, preferably from 1 to 10 μm and in particular from 3 to 7 μm in thickness are formed.

In a first embodiment of the invention a film made of polyamide, in particular oriented polyamide (oPA), is arranged on a functional layer of an inorganic-organic hybrid polymer or on the printing thereof of the backing layer coated according to the invention made of polyester, polyamide or polypropylene of the aforementioned type, by way of a laminating adhesive, and on this film is arranged the sealable, inner, exposed film made of polypropylene which is also applied by means of a laminating adhesive. The backing film forms the outer, exposed film of the packaging material. Counter-printing may be applied to said functional layer.

In a second embodiment, the backing layer consists of polyester, polypropylene or polyamide, and preferably of an oriented polyamide, the functional layer of an inorganic-organic hybrid polymer forming the outer, exposed surface. Printing may also be arranged on said functional layer. The sealable, inner, exposed film or layer preferably made of polypropylene, in particular cast polypropylene is arranged on the backing film, for example, by means of laminating adhesive.

In a third embodiment of the invention, a composite film comprising the sealable, inner, exposed film or layer made of polypropylene is arranged on a functional layer of an inorganic-organic hybrid polymer of the backing film coated according to the invention made of polyester, polyamide or polypropylene of the aforementioned type. The composite film may be a coextrusion coated, coextruded and/or extrusion laminated polyamide/polypropylene film, the film or layer made of polypropylene forming the closing outer film. Coextruded layers made of polyamide are advantageously unstretched. The films or layers of the composite film may be connected by way of a bonding agent and/or primer. Counter-printing may also be applied to said functional layer.

In a fourth embodiment of the invention, the sealable, inert, exposed film made of polypropylene is arranged directly on a functional layer of an inorganic-organic hybrid polymer of a backing film coated according to the invention made of polyester, polyamide or polypropylene of the aforementioned type. A further film applied by means of laminating adhesive, made of polyester or a polyamide, in particular an oriented polyamide, may be arranged between the functional layer of an inorganic-organic hybrid polymer and the sealable film. Counter-printing may also be applied to said functional layer.

A fifth embodiment of a packaging material for sterile products according to the invention consists of a coated monofilm and comprises a backing film made of a polypropylene of the aforementioned type with a coating according to the invention, a functional layer of an inorganic-organic hybrid polymer being the outer, exposed layer of the packaging material. Printing may be arranged on the free surface of said functional layer. The backing film is simultaneously also the sealable film facing the packaging content.

A sixth embodiment of a packaging material for sterile products according to the invention comprises a backing film coated according to the invention made of a polyester, polyamide or polypropylene of the aforementioned type with a thin ceramic layer and a functional layer of an inorganic-organic hybrid polymer arranged thereon. A further, optionally counter-printed plastic film, preferably made of a polyester, is applied on said functional layer. One or more further plastic films are laminated on the second side of the backing film remote from the thin ceramic layer, one of these plastic films being the sealable, inner, exposed film or layer preferably made of a polypropylene.

The sealable, inner, exposed film made of polypropylene expediently comprises a thickness of 35 to 200 μm, preferably 50 to 150 μm and in particular 70 to 110 μm. The films made of polyamide or polyester of the film composite expediently have a layer thickness of 5 to 100 μm, preferably 5 to 50 μm and in particular 10 to 20 μm.

The coextrusion coated, coextruded or extrusion laminated polyamide, polypropylene film may also have, for example, a total thickness of 30 to 125 μm, preferably 50 to 90 μm and in particular 60 to 80 μm. The thickness of the polyamide layer in the polyamide/polypropylene film may be, for example, 5 to 50%, expediently 10 to 30% and in particular 15 to 25% of the total thickness of the coextrusion coated, coextruded, or extrusion laminated film.

The flexible packaging materials for sterile products expediently have total thicknesses of 10 to 1000 μm, preferably 20 to 500 μm and in particular 30 to 200 μm.

Each film used in the film composite fulfils a specific function. The thin ceramic layer and the functional layer of an inorganic-organic hybrid polymer are applied to the backing layer. The backing layer also increases the strength of the packaging material. The further films made of polyamide or polyester used from case to case act in a supporting and strength-increasing manner in the film composite. The inner, exposed film made of polypropylene which is generally selected to be relatively thick, improves the puncture resistance and is also sealable.

The invention also relates to a method for producing a flexible packaging material for sterile products made of a film composite with barrier properties comprising a backing film made of polyamide, polyester or polypropylene and a thin ceramic layer arranged thereon.

The method is distinguished in that a functional layer comprising or consisting of an inorganic-organic hybrid polymer is applied and fixed, i.e. cured, on the thin ceramic layer of the backing film in a printing unit. Said functional layer is preferably applied in a mass per unit area of less than 1 g/m².

The functional layer comprising or consisting of an inorganic-organic hybrid polymer is preferably applied in a printing method, in particular a gravure printing method, on the thin ceramic layer and cured thermally or by means of energy-rich radiation. The curing of said functional layer which directly follows the layer application is expediently a part of the printing process, in particular the gravure printing process. Thermal curing preferably takes place at temperatures of less than 130° C., in particular less than 100° C.

In a preferred embodiment of the invention, printing or counter-printing is also applied to the functional layer comprising or consisting of an inorganic-organic hybrid polymer by means of a printing method, in particular a gravure printing method. The application of said functional layer and the printing by a printing method, in particular a gravure printing method, preferably takes place in-line in directly consecutive steps. The functional layer and the printing are preferably applied by the same printing method.

The application of said functional layer and the printing or counter-printing preferably take place in a common printing unit. The functional layer is expediently applied and fixed, preferably thermally fixed, in a first printing station in a printing run or printing operation. Printing or counter-printing is applied and fixed, in particular thermally fixed, in one or more printing runs or printing operations, to the functional layer.

Further films can be laminated to the optionally printed, functional layer comprising or consisting of an inorganic-organic hybrid polymer in subsequent method steps. The production of the finished film composite as a packaging material for sterile products expediently takes place with the aid of known method steps. The backing layer is preferably provided in first method steps according to the invention with a functional layer and optionally printing and optionally brought together in subsequent method steps with further films to form a film composite, as a packaging material for sterile products.

The present invention also relates to the use of the film according to the invention or film composite for producing packagings for sterile products, i.e. sterilisable packagings, preferably sterile product packagings for food for humans and animals.

The film or film composite according to the invention is used in particular for producing sterilisable bag packagings. Sterilisable bag packagings of this type can be formed, for example, from a portion of the composite material by folding and sealing or from two lateral parts of the present composite material by u optionally folding and û sealing or from a plurality of lateral parts of the composite material by—optionally folding and—sealing. Typical bag packagings are flat bags, standing bags, sealed edge bags, spacious bags, standable spacious bags, lateral edge flat bags, flat-end bags or else sacks, such as welded flat or folded sacks, etc. The sterilisable bag packagings for their part can be used for filling products, such as lumpy, pulpy, pasty, semi-liquid or liquid food for humans and animals or for luxury foods. Further exemplary uses of this type of bag are cosmetics or body care products in pasty or liquid form. Other examples are pharmaceutical products or therapeutic agents. The film or film composite according to the invention can also be used for producing sterilisable cover films, in particular peelable cover films for cups or dishes made of, for example, polypropylene. Said cover films are used in particular as packaging means for cup packagings for yoghurts or fruit cocktails.

The film or film composite according to the present invention is sterilisable without delamination of the individual layers or loss of strength, for example by a heat treatment at 110 to 140° C., preferably 121° C. to 135° C., for 10 to 60 minutes, preferably 30 minutes. The packaging material for sterile products according to the invention is also suitable for producing packagings for pasteurising or hot filling of food at temperatures of, for example, over 80° C.

The packaging material for sterile products according to the invention, in comparison to conventional packaging materials for sterile products without a functional layer made of an inorganic-organic hybrid polymer, even after stressing under extreme sterilisation conditions, demonstrates excellent and durable retention of the barrier properties with respect to gases such as oxygen and water vapour. The advantageous properties are, surprisingly, already achieved in comparatively thin functional layers, which is why they are economical despite the use of comparatively expensive functional layers of this type, such as for example ORMOCER®e.

The film composite A according to FIG. 1 comprises a first, outer film 1 made of polyethylene terephthalate (PET) with a thickness of 12 μm, on which a thin ceramic layer 2 made of SiO₂ with a thickness of 50 nm is arranged. The backing layer may also consist of oriented polyamide (oPA) or polypropylene, in particular cast polypropylene (cPP). A functional layer of an inorganic-organic hybrid polymer 3 with a layer thickness of 0.5 μm is arranged on the thin ceramic layer 2. Printing 6 may be applied, case by case, onto said functional layer 3. The sealable, inner, exposed film 5 made of polypropylene is arranged on said functional layer 3 or its printing 6 by way of a laminating adhesive 4. The film 5 made of polypropylene has a thickness of 110 μm. The laminating adhesive is based on a polyurethane polyethylene terephthalate (PET) (PUR/PET)-two-component adhesive system and is present in a thickness of 5 μm.

The film composite B according to FIG. 2 contains a backing film 11 made of polyethylene terephthalate (PET) with a thickness of 12 μm, on which a thin ceramic layer 12 made of SiO₂ with a thickness of 50 nm is applied. The backing film can also consist of oriented polyamide (oPA) or of polypropylene, in particular of cast polypropylene (cPP). Arranged on the thin ceramic layer 12 is a functional layer made of inorganic-organic hybrid polymer 13 with a layer thickness of 0.5 μm. Printing 18 may be applied, case by case, to said functional layer 13. A film 15 made of polyamide is arranged on the functional layer 13 by way of a laminating adhesive 14, on which film 15 in turn the sealable, inner, exposed film 17 made of polypropylene is arranged by way of a laminating adhesive 16. The film made of polyamide 15 consists of biaxially oriented polyamide with a thickness of 15 μm. The film 17 made of polypropylene has a thickness of 75 μm. The laminating adhesive is based on a PUR-two-component adhesive system and is present in a thickness of 5 μm.

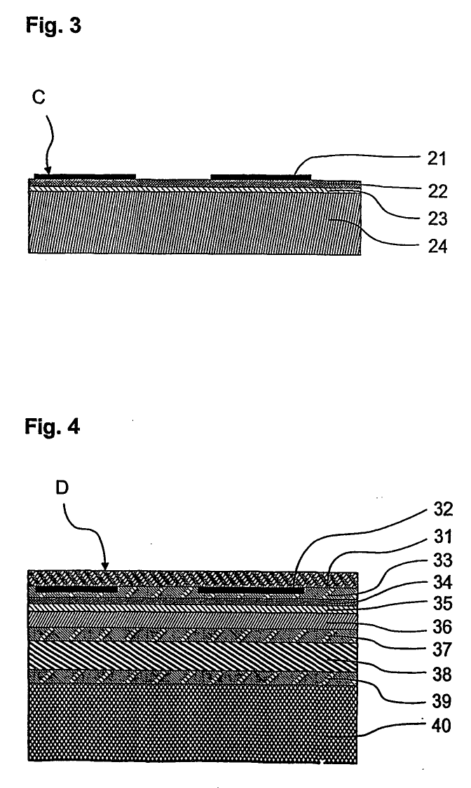

The film C according to FIG. 3 consists of a monofilm with a backing film 24 made of polypropylene with a thickness of 75 μm, which is also the sealable film. The thin ceramic layer 23 made of SiO₂ with a thickness of 50 nm is arranged on the backing film. A functional layer made of inorganic-organic hybrid polymer with a layer thickness of 0.5 μm is arranged on the thin ceramic layer 23. Printing 21 is arranged, case by case, on said functional layer 22. The functional layer 22 or its printing 21 forms the outer, exposed layer of the film C.

The film composite D according to FIG. 4 comprises a sealable, inner, exposed film 40 made of polypropylene, in particular of cast polypropylene (cPP) with a thickness of 75 μm. A film 38 made of biaxially oriented polyamide is arranged on the sealable film 40, on which film 38 in turn a backing film 36 is arranged by way of a laminating adhesive 37. The backing film 36 comprises a thin ceramic layer 35 made of SiO₂ with a thickness of 50 nm, on which a functional layer of an inorganic-organic hybrid polymer 34 with a layer thickness of 0.5 μm is arranged. An outer, exposed film made of polyethylene terephthalate (PET) with a thickness of 12 μm printed with a counter-print 32 is arranged on said functional layer 34 by way of a laminating adhesive 33. Exposed film layer 31 of PET is on functional layer 34. The laminating adhesive is based on a PUR-two-component adhesive system and is present in a thickness of 5 μm.

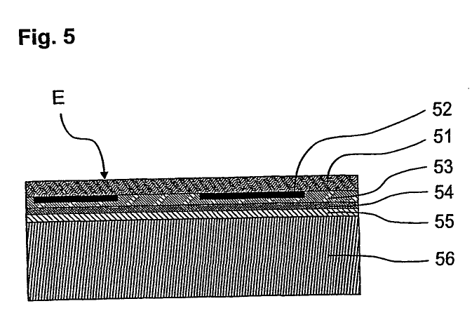

The film composite E according to FIG. 5 comprises a sealable, inner, exposed backing film 56 made of polypropylene, in particular of cast polypropylene (cPP), with a thickness of 75 μm. A thin ceramic layer 55 made of SiO₂ in a thickness of 50 nm is deposited on the backing layer 56, on which thin layer 55 a functional layer of an inorganic-organic hybrid polymer 54 with a layer thickness of 0.5 μm is arranged. An outer, exposed film 51 made of polyethylene terephthalate (PET) 51 with a thickness of 12 μm printed with a counter-print 52 is arranged on said functional layer 54 by way of a laminating adhesive 53. The laminating adhesive is based on a PUR-two-component adhesive system and is present in a thickness of 5 μm.

The following tables show comparative measurements of the oxygen permeability of the film composite A or B with conventional film composites without a functional layer of an inorganic-organic hybrid polymer, wherein the film composites were subjected to different sterilisation conditions. The measured values given in the table correspond to individual measurements. The oxygen permeability is given in cm³/m² per bar [b] and per day [d] “Flexed” means under flexural stress owing to alternating folding and bending straight of the film composite. Table A.1 to A.5 reproduces measured results with the film composite A, wherein these were modified for comparison purposes to the extent that the functional layer of an inorganic-organic hybrid polymer according to details in Table A.2 to A.5 can have different layer thicknesses or be omitted or replaced by a conventional lacquer layer.

Table B.1 to B.2 reproduce measured results with the film composite B, wherein these were modified for comparison purposes to the extent that the functional layer of an inorganic-organic hybrid polymer according to details in Table B.2 can be replaced by a conventional lacquer layer.

Film composite A with a functional layer of an inorganic-organic hybrid polymer in an application quantity of 0.5 g/m²:

TABLE A.1

| | Oxygen permeability |
|---|---|
| Sterilisation conditions | [cm³/m² · d · b] |
| 121° C. for 30 minutes | 0.2/0.2 |
| 121° C. for 30 minutes, 20 × flexed | 1.0/1.0 |
| 135° C. for 30 minutes | 0.2/0.3 |
| 135° C. for 30 minutes 20 × flexed | 1.1/1.3 |

Film composite A with a functional layer of an inorganic-organic hybrid polymer in an application quantity of 1.0 g/m²:

TABLE A.2

| | Oxygen permeability |
|---|---|
| Sterilisation conditions | [cm³/m² · d · b] |
| 121° C. for 30 minutes | 0.1/0.3 |
| 121° C. for 30 minutes, 20 × flexed | 0.8/1.2 |
| 135° C. for 30 minutes | 0.3/0.4 |
| 135° C. for 30 minutes 20 × flexed | 1.0/0.5 |

Film composite A, with a functional layer of an inorganic-organic hybrid polymer in an application quantity of 0.5 g/m² and printing arranged on said functional layer:

TABLE A.3

| | Oxygen permeability |
|---|---|
| Sterilisation conditions | [cm³/m² · d · b] |
| 121° C. for 30 minutes | 0.1/0.1/0.2/0.2 |
| 121° C. for 30 minutes, 20 × flexed | — |
| 135° C. for 30 minutes | 0.1/0.2/0.2/0.3 |
| 135° C. for 30 minutes 20 × flexed | — |

Film composite A with a conventional PVC lacquer system in an application quantity of 1.0 g/m² instead of a functional layer of an inorganic-organic hybrid polymer:

TABLE A.4

| | Oxygen permeability |
|---|---|
| Sterilisation conditions | [cm³/m² · d · b] |
| 121° C. for 30 minutes | 0.8/0.8 |
| 121° C. for 30 minutes, 20 × flexed | — |
| 135° C. for 30 minutes | 13.1/18.4 |
| 135° C. for 30 minutes 20 × flexed | — |

Film composite A with a conventional PET/PUR lacquer system in an application quantity of 1.0 g/m² instead of a functional layer of an inorganic-organic hybrid polymer:

TABLE A.5

| | Oxygen permeability |
|---|---|
| Sterilisation conditions | [cm³/m² · d · b] |
| 121° C. for 30 minutes | 0.6/1.0 |
| 121° C. for 30 minutes, 20 × flexed | — |
| 135° C. for 30 minutes | 8.0/17.1 |
| 135° C. for 30 minutes 20 ×flexed | — |

Film composite A without a functional layer of an inorganic-organic hybrid polymer and without the lacquer layer replacing this functional layer:

TABLE A.6

| | Oxygen permeability |
|---|---|
| Sterilisation conditions | [cm³/m² · d · b] |
| 121° C. for 30 minutes | 0.9/1.1 |
| 121° C. for 30 minutes, 20 × flexed | 9.6/11.3 |
| 135° C. for 30 minutes | 27.8/28.3 |
| 135° C. for 30 minutes 20 × flexed | — |

Film composite B with a functional layer of an inorganic-organic hybrid polymer in an application quantity of 0.5 g/m²:

TABLE B.1

| | Oxygen permeability |
|---|---|
| Sterilisation conditions | [cm³/m² · d · b] |
| 121° C. for 30 minutes | 0.3/0.4 |
| 121° C. for 30 minutes, 20 × flexed | 2.7/2.9 |
| 135° C. for 30 minutes | 0.3/0.3 |
| 135° C. for 30 minutes 20 × flexed | 2.5/5.6 |

Film composite B with a lacquer layer of an application quantity of 0.5 g/m² instead of a functional layer of an inorganic-organic hybrid polymer, wherein the production of the lacquer is carried out according to the teaching of patent U.S. Pat. No. 5,645,923 from Toppan Printing Co. Ltd. and the composition thereof corresponds to one of the embodiment variations disclosed in the mentioned patent:

TABLE B.2

| | Oxygen permeability |
|---|---|
| Sterilisation conditions | [cm³/m² · d · b] |
| 121° C. for 30 minutes | 0.6/0.7/0.9/2.2 |
| 121° C. for 30 minutes, 20 × flexed | 3.6/4.3 |
| 135° C. for 30 minutes | 2.9/4.7 |
| 135° C. for 30 minutes 20 × flexed | 13.1/13.8 |

The measured results show that in the application according to the invention of a very thin functional layer of an inorganic-organic hybrid polymer in the film composite the barrier properties are scarcely impaired in the case of an increase of the sterilisation temperature from 121° C. to 135° C. However, if the same film composite without a functional layer of an inorganic-organic hybrid polymer, or optionally with a conventional protective lacquer layer instead of said functional layer, is subjected to the same sterilisation conditions, it is shown that the increase in the sterilisation temperature from 121° C. to 135° C. entails a massive impairment of the barrier properties. In these cases, the oxygen permeability sometimes increases by more than 10-fold in the case of an increase in the sterilisation temperature according to the test series.

1-52. (canceled)

53. A method for producing a flexible packaging material for sterile products made of a film composite having gaseous barrier properties, the film composite comprises a backing film formed of a material selected from the group consisting of polyamide, polyester and polypropylene, a ceramic layer having a thickness of 5-200 nm on the backing film and a functional layer on the ceramic layer, wherein the functional layer has a layer thickness of less than 1 μm and consists of an inorganic-organic hybrid polymer comprising an inorganic network and an organic network comprising polymerisable organo-functional groups which are crosslinked to one another, the method comprises (1) synthesizing the inorganic-organic hydrid polymer by a sol-gel method, (2) producing an inorganic network by controlled hydrolysis and condensation of organically modified Si-alkoxides, (3) fixing the organo-functional groups to the inorganic network and (4) crosslinking the organo-functional groups by polymerization, by one of a thermal or redox initiated manner or by means of energy-rich radiation, to form the organic network.

54. A method for producing a flexible packaging material for sterile products made of the film composite according to claim 54, comprises applying the functional layer to the ceramic layer on the backing film by means of a printing method.

55. A method according to claim 53, wherein the functional layer is applied in a mass per unit area of less than 1 g/m².

56. A method according to claim 54, wherein the functional layer is applied in a mass per unit area of less than 0.8 g/m² and more than 0.1 g/m².

57. A method according to claim 54, wherein the functional layer is applied in a mass per unit area of more than 0.5 g/m².

58. A method according to claim 54, wherein the functional layer is applied by a gravure printing method.

59. A method according to claim 58, wherein printing or counter-printing is applied to the functional layer of the gravure printing method.

60. A method according to claim 59, wherein the application of the functional layer and the printing or counter-printing are carried out in a common printing unit, wherein the functional layer is applied and fixed at a first printing station in a printing run and the printing or counter-printing is applied and fixed at one or more subsequent printing stations in one or more printing runs.

61. A method according to claim 59, including thermal curing the applied functional layer at a temperature of less than 100° C.

62. A method according to claim 53, wherein the inorganic network further comprises metal alkoxides.

63. A method according to claim 62, wherein the metal alkloxides are aluminum alkoxides.

64. A method according to claim 53, wherein the film composite further comprises a sealable, inner film.

65. A method according to claim 64, wherein the sealable, inner film is adhesively bonded on the functional layer.

66. A method according to claim 64, wherein the sealable, inner film is made of a polypropylene.

67. A method according to claim 53, wherein a film of polyamide is arranged on the functional layer and a sealable, inner film is arranged on the film of polyamide.

68. A method according to claim 56, wherein the ceramic layer has a layer thickness of 5 to 200 nm.

69. A method according to claim 56, wherein the ceramic layer has a layer thickness of 20 to 150 nm.

70. A method according to claim 56, wherein the ceramic layer has a layer thickness of 50 to 100 nm.

71. A method according to claim 64, wherein the sealable, inner film has a thickness of 50 to 200 μm.

72. A method according to claim 64, wherein the sealable, inner film has a thickness of 60 to 120 μm.

73. A method according to claim 64, wherein the sealable, inner film has a thickness of 70 to 100 μm.

74. A method according to claim 65, wherein the adhesive is selected from the group consisting of a solvent-containing, solvent-free and water-containing laminating adhesive and has a thickness of 2 to 15 μm.

75. A method according to claim 53, wherein the backing film has a thickness of 5 to 100 μm.

76. A method according to claim 53, wherein the backing film has a thickness of 5 to 50 μm.

77. A method according to claim 53, wherein the backing film has a thickness of 10 to 20 μm.

78. A method according to claim 53, wherein the ceramic layer is selected from the group consisting of (1) silica of the formula SiOₓ, wherein x is a number from 1 to 2, and (2) aluminium oxide of the formula Al_{y}O_{z}, wherein y/z represents a number from 0.2 to 1.5, and mixtures thereof.

79. A method according to claim 78, wherein the ceramic layer is selected from the group consisting of SiO₂, Al₂O₃ and mixtures thereof.
